(19) United States
(12) Patent Application Publication
(10) Pub. No.: US 2008/0017499 A1
(43) Pub. Date: Jan. 24, 2008

(54) Solar Collector

(76) Inventor: Bruce Winston Brockhoff, Dromana (AU)

Correspondence Address: BIRCH STEWART KOLASCH & BIRCH, PO BOX 747, FALLS CHURCH, VA, 22040-0747, US

(21) Appl. No.: 11/631,529

(22) PCT Filed: Jun. 15, 2005
(86) PCT No.: PCT/AU05/00852

§ 371 Date: Jan. 4, 2007

Related U.S. Application Data
(60) Provisional application No. 60/585,523, filed on Jul. 6, 2004.

(51) Int. Cl. C02F 1/14; F24J 2/36

(52) U.S. Cl. 203/11; 126/625; 126/707; 203/91

(57) ABSTRACT

A solar collector (1) is provided from plastics material sheets. There is a base part (3) and a first covering (5) overlying the base part (3). A first chamber (9) exists between the base part (3) and the first covering (5). The sheets are scaled at their side edges. The surface of the base part (5) that faces internally of the first chamber is heat absorbing to assist solar energy absorption into the first chamber (9). The first chamber (9) is supplied with a positive pressure air from a fan or blower and inflates the collector. The air is, in turn, heated by solar energy absorbed and can be used to heat water or other liquids directly within the collector (1) or the heated air can be taken from the collector (1) and used for heating. In a variation a second covering (7) overlies the first covering (5) and provides a second chamber (11) which is also inflated with positive pressure air. A method of obtaining drinkable/potable water using the solar collector is also disclosed. In addition a method of recovering minerals from liquids using the solar collector is also disclosed. Air in the second chamber acts as a heat insulating medium relative to atmospheric air and allows solar energy to be collected in the air in the first chamber by solar energy from atmosphere passing through the air in second chamber.

### FIELD OF THE INVENTION

This invention relates to a solar collector and relates particularly but not exclusively to a collector that is used to heat air or water or other like media.

This application is based on and claims the benefit of the filing date of U.S. application Ser. No. 60/585,523 filed 6 Jul. 2004 the contents of which are incorporated herein by reference in its entirety.

### BACKGROUND ART

Hitherto extensive research has been undertaken into solar collectors for heating fluids such as water and/or air. For solar collectors for swimming pools the heat collectors, in general, comprise black plastics material either in pipe form or in black interconnected spaghetti type extruded form. The collector material is placed on a surface such as a roof of a building and the swimming pool water is circulated through the collectors and heated by the sun. Many designs have been proposed but, in general, the finished collectors are expensive.

In domestic hot water heating units, and indeed similar commercial hot water heating units, exotic collector constructions have been devised. In one example, glass collector tubes have been evacuated of air and the internal surfaces of the glass tubes coated with exotic materials to enhance solar collection. Water is then passed through water pipes that extend longitudinally within the tubes and is heated in the tubes by the sun. Whilst these types of water collectors can be relatively efficient compared to the swimming pool solar collectors referred to above, the comparative per unit cost of the collectors is considerable.

Thus, in the past, traditional thinking has been to provide solar collectors which are as efficient as possible for the exposed surface area of the collectors and for the cost of the collectors. The thinking has not been directly connected with low cost collectors. Accordingly, this is one contributing factor to the lack of wide spread adoption of the technology.

### STATEMENT OF INVENTION

Therefore, according to a first broad aspect of the present invention there is provided a solar collector with a plastics material sheet base part, and a plastics material sheet first covering overlaying the base part, and a plastics material sheet second covering overlaying the first covering,

the first covering and the second covering being sealingly interconnected relative to the base part to define first and second air chambers, said first chamber being between said base part and said first covering, and said second chamber being between said first covering and said second covering,

the surface of the base part that faces internally of the first chamber being heat absorbing to assist solar energy absorption into the first chamber and the second covering being transparent or translucent to allow solar energy to transmit therethrough,

said collector being such that air in the second chamber will act as a heat insulating medium relative to atmosphere for air in the first chamber, and will allow solar energy to be collected in the air in the first chamber by solar energy from atmosphere passing though the air in the second chamber.

In some examples, the heat collected by the solar collector can be used to preheat fluids that are then passed through known traditional solar collectors that heat those fluids. In this way, significantly improved efficiency can be achieved for substantially little extra cost over and above the cost of the traditional solar collectors. This cost is substantially less than a corresponding duplication of the known solar collectors.

In one embodiment air is fed under pressure into the first chamber.

In one embodiment the base part and the first covering and the second covering are flexible sheets, and the collector is inflated from a collapsed condition to an in use condition.

In one embodiment the base part and the first covering have substantially the same transverse dimensions in a direction across the faces thereof.

In one embodiment the second covering has a greater transverse dimension in a direction across the face thereof than a corresponding direction across the base part or the first covering but wherein the sealing to the base part is approximately at the same sealing as the sealing of the first covering to the base part so that when the first and second chambers are inflated, the first chamber will have a greater volume than the second chamber.

In one embodiment the surface of the base part opposite to the surface that is heat absorbing is configured for inhibiting heat radiation transfer from the first chamber.

In one embodiment the configuration is by colouring the surface of the base part opposite to the surface that is heat absorbing a lighter colour than the colour of the surface that is heat absorbing.

In one embodiment the base part, the first covering, and the second covering are of UV stabilised P.V.C. sheets.

In one embodiment the sealing of the first covering relative to the base part is by a sealing weld or bond.

In one embodiment the sealing of the second covering relative to the base part is by a sealing weld or bond.

In one embodiment the sealing of the first covering and the second covering relative to the base is at a common sealing weld or bond.

In another embodiment the base part is relatively rigid compared to the first covering or second covering.

In one embodiment the base part is substantially thicker than the thickness of the first covering or the second covering and has a substantially higher thermal conductivity insulating property to that of the first covering or the second covering.

In one embodiment the solar collector be manufactured as a collapsed elongate strip collector with the sealing of the first covering and second covering relative to the base part being by sealing at each longitudinal side edge of the strip, and so that the collector strip can be cut to a desired length and the cut ends either closed or directed to an air outlet to complete the collector circuit.

In one embodiment position fastening means is provided along the side edges of the strip to permit fasteners to be applied to the collector to co-operate with the position fastening means to hold the base against an underlying supporting surface.

In one embodiment the position fastening means comprises an elongate member or the like extending along each side edge of the strip and integrally attached relative to the base along the length of the collector.

In one embodiment air that is heated in said first chamber is directed out of the collector through ducting connected with the first chamber by the air pressure created in the first chamber by air pump means used to inflate the first chamber.

In another embodiment the first chamber has a heat collecting passageway therein for receipt of water, so in use, water will be heated in said heat collecting passageway by air that is heated in said first chamber.

The heat collecting passageway is connected with a hot water storage tank by means of an interconnected water passageway circuit.

In one embodiment the interconnecting water passageway circuit is connected with a solar hot water heater panel so that water heated by the air that is heated in the first chamber acts as a pre-heater for the solar heater panel and acts to supplement the heat collected by the solar heater panel.

In another embodiment the air that is heated in the first chamber is passed through an interconnecting air passageway outlet circuit so that the output air will pass to a heat storage bank and provide heat to the heat storage bank so that, at a subsequent time, the air passageway outlet circuit can circulate air to recover heat from the heat storage bank without the circulated air passing through the first chamber.

In another embodiment utilizing any of the above concept, a layer of liquid is introduced onto the base part through a header and, in use, allowed to evaporate in the first chamber and condense on the under surface of the first covering from where it can be collected.

The first covering is upwardly convex so that water that condenses on the under surface thereof can flow by gravity to the side edges thereof from where it can be collected.

Gutters are provided at the side edges of the collector and within the first chamber to receive water that condenses on the under surface of the first covering and which has moved by gravity to side edges of the collector.

Liquid flow control restraining means are provided in the first chamber to limit the flow rate of the liquid along the length of the collector whereby to enhance evaporation of the liquid within the first chamber.

The liquid flow control restraining means comprises surface undulations on the surface of the base part that faces inwardly of the first chamber.

### BRIEF DESCRIPTION OF DRAWINGS

In order that the invention can be more clearly ascertained examples of embodiments will now be described with reference to the accompanying drawing wherein:

FIG. 1 is a perspective view of one preferred solar collector according to the present invention.

FIG. 2 is a transverse cross sectional view of the solar collector shown in FIG. 1, and taken across section line 2-2,

FIG. 3 is a transverse cross sectional view of the solar collector shown in FIG. 1 taken across section line 3-3 shown in FIG. 1.

FIG. 4 is a view similar to FIG. 2 showing connection of fluid passageways to the flume.

FIG. 5 is a schematic diagram showing connection of fans or pumps for providing a fluid under pressure into the solar collector of FIG. 1.

FIG. 6 is a further schematic diagram showing the taking off of heated fluid from the solar collector of FIG. 1.

FIG. 7 is a further schematic diagram showing a system similar to that in FIG. 6 but where the fluid passes to a heat storage bank.

FIG. 8 is a transverse cross sectional view similar to that of FIG. 4 but showing an alternative embodiment with internal heat exchanger passageways.

FIG. 9 is a schematic view showing interconnection of a system using a solar collector of the type shown in FIG. 8.

FIG. 10 is a further schematic view showing part of the schematic diagram of FIG. 9, and where the fluid heated by the solar collector is used as a preheater for a fluid that is heated in a conventional solar fluid heater.

FIG. 11 is a view similar to that of FIG. 2 showing an alternative embodiment.

FIG. 12 is a close up side edge view of the solar collector shown in previous embodiments, and showing a form of sealing at the side edges.

FIG. 13 is a view similar to FIG. 12 showing how the solar collector may be attached to an underlying supporting surface such as the ground.

FIG. 14 is a view similar to FIG. 13 showing an alternative embodiment for enhancing fastening to the supporting surface.

FIG. 15 is a close-up transverse cross sectional view of one side edge of the solar collector showing use of flap control valves for minimising fluid escape from the solar collector under certain conditions.

FIG. 16 is a top perspective view showing a way in which the collector ends may be closed.

FIG. 17 is an in view showing a further stage in the closing of the ends relative to that shown in FIG. 16.

FIG. 18 is a transverse cross sectional view of an alternative embodiment to that shown in FIGS. 1 through 4.

FIG. 19 is a transverse cross sectional view of an even further embodiment to that shown in FIGS. 1 through 4.

FIG. 20 is a transverse cross sectional view showing a still further embodiment and variation of the embodiment shown in FIGS. 1 through 4.

FIG. 21 is a transverse cross sectional view of a still further embodiment used for collecting drinking/potable water from recyclable waste, or water otherwise not readily safely drinkable.

FIG. 22 is a close-up transverse cross sectional view, similar to FIG. 21 showing a side edge of the embodiment in FIG. 21.

FIG. 23 is a longitudinal side view of an arrangement for utilizing the inventive concept shown in FIGS. 21 and 22.

FIGS. 24a and 24b are diagrammatic close-up views of a header distribution tank and a collection trough for utilization in the embodiment of FIGS. 21 through 23.

FIGS. 25a and 25b are close-up diagrammatic views showing closing of the ends of the flume for the embodiment of FIGS. 21 through 24.

FIG. 26 is a diagrammatic view showing an arrangement on the surface of a base part of the flume for the embodiment of FIGS. 21 through 25 to distribute a water layer thereover.

FIG. 27 is a view similar to that of FIG. 26 showing an alternative arrangement,

FIG. 28 is a hydraulic circuit diagram showing interconnection with a collector flume for implementing the embodiment of FIGS. 21 through 27.

FIG. 29 is a close-up transverse cross sectional view of an alternative embodiment at a side edge of the collector.

FIG. 30 is a view similar to that shown in FIG. 29 showing the collector 1 in an inflated condition.

FIG. 31 is view of a further embodiment similar to that of FIG. 30 showing the use of a thermally insulating ground sheet,

FIG. 32 is a view of a further embodiment similar to that of FIG. 8,

FIG. 33 is a view of a further embodiment similar to that shown in FIGS. 1-3.

FIG. 34 is a view of a further embodiment similar to that shown in FIG. 2.

FIG. 35 is a view of a further embodiment similar to that shown in FIGS. 8 and 9.

FIG. 36 is a view of another embodiment similar to that shown in FIGS. 21 and 22.

FIG. 37 is a close up view showing detail in FIG. 36.

FIG. 38 is a schematic view showing an alternative embodiment to that shown in FIGS. 21-30

FIG. 39 is a schematic view of a still further embodiment.

FIG. 40 is a schematic view of a still further embodiment,

FIG. 41 is a schematic view of a still further embodiment.

FIG. 42 is a perspective view of a still further embodiment used for growing crop.

FIG. 43 is a plan view of the embodiment of FIG. 42 with soil and crop omitted, and

FIG. 44 is a perspective view of a still further embodiment.

### DETAILED DESCRIPTION OF EXAMPLES

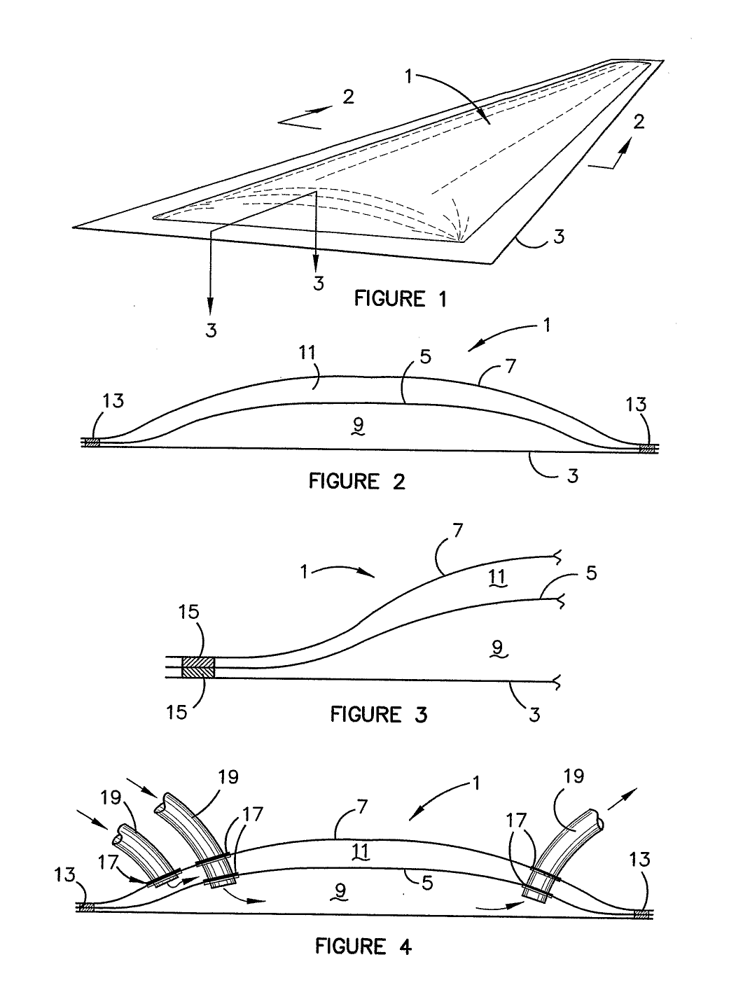

Referring firstly to the solar collector shown in FIGS. 1 through 4 it can be seen that the solar collector is in the form of a flume 1 that has a base part 3 of a plastics material UV stabilised P.V.C. sheet. The P.V.C. sheet is typically about 180 microns in thickness. The exact thickness is not critical.

Typically, the base part is an elongate strip, and in one embodiment it is typically one meter wide. The length of the flume may be of any desired length but typically it is many meters in length and can extend over many hundreds of meters if required. A plastics materials sheet first covering 5 overlays the base part 3. A further plastics material sheet second covering 7 overlays the first covering 5. The first covering 5 and the second covering 7 are sealingly interconnected relative to the base part 5 to define deflated first air chamber 9 and second air chamber 11. The sealing is preferably by welding along the side edges of the flume and has been shown generally by seal 13 at each side edge. It can therefore be seen that the first chamber 9 is between the base part 3 and the first covering 5, and that the second chamber 11 is between the first covering 5 and the second covering 7.

The base part 3 is typically UV stabilised P.V.C. sheet of approximately 180 microns in thickness. The base 3 has the surface that faces internally of the first chamber 9 of a heat absorbing property to assist solar energy absorption into the first chamber 9. Typically this heat absorbing is by colouring the surface black. The second covering 7 of the second chamber is transparent or translucent and typically comprises a clear or semi-clear UV stabilised P.V.C. sheet of approximately 180 microns in thickness. Hot house UV stabilised P.V.C. sheet has been found to be one suitable material. The first covering 5 is of similar material to the second covering 7. Thus, as the base 3 is typically coloured black or some other dark colour it enhances solar energy absorption into the first chamber 9. The second covering 7 and the first covering 5 are transparent or translucent and desirably clear or substantially clear to allow solar energy to be transmitted therethrough.

Referring now to FIG. 3 it can be seen how the ends of the elongate strip 1 can be closed after the strip is cut to a desire length. In this embodiment, an adhesive medium 15 such as a double sided adhesive strip medium is applied between the base part 3 and the first covering 5, and the second covering 7 and the first covering 5. Thus, the adhesive medium provides for closing of the cut ends of the flume 1 by sealing them.

The sealing along the side edges of the strip at seal 13 is typically effected by a welding or bonding in an elongate strip along the side edges. The collector is therefore analogous to an elongate bag or tube that can be inflated for use, and that when inflated the collector is like a double glazed collector.

By inspecting FIG. 2 it can be seen that the base part 3 and the first covering 5 have substantially the same transverse dimensions in a direction across of the face of the flume. It can also be seen that the second covering 7 has a greater transverse dimension across the face thereof than a corresponding dimension across the base part 3, or across the first covering 5. It should also be noted that the sealing of the base part 3, first covering 5, and second covering 7 is at the same general sealing position as the sealing of the first covering 5 to the base part 3. Accordingly, when at least the second chamber 11 is inflated with atmospheric air, the first chamber 9 will have a greater volume than the second chamber 9. By inflating just the second chamber 11, the collector will assume the cross sectional shape as shown in the figures. The second chamber 11 then acts as a thermal insulator to atmospheric air, for the air that is in the first chamber 9. Desirably both the second chamber 11 and the first chamber are inflated as this provides a positive inflation to the first chamber 9, and holds the collector in a stable inflated condition. It also holds the first covering 5 off the top of the base part 3.

FIG. 2 shows that the base part 3 is typically held flat and that the inflation of the first chamber 9 and second chamber 11 is such that the first covering 5 inflates upwardly away from the flat and generally planar base part 3. Similarly, the second covering 7 inflates away from the planar base part 3.

Referring now to FIG. 4 it can be seen how air passageways can be interconnected with the flume 1 to allow inflation of the first chamber 9 and second chamber 11, and to allow heated air output from the first chamber 9. Here, flexible plastics material tubing 19 of approximately 5-10 cm in diameter is fitted into the base part 3 and/or the second covering 7 by means of known prior art coupling connectors 17. The tubing 19 allows a pressurized air to enter into the first chamber 9 and into the second chamber 11 to inflate those chambers, and also allows heated air to pass out of the first chamber 9 for subsequent use. The coupling connectors 17 are typically plastics material flanges that locate relative to the tubing 19 and clamp the sheet material of the base part 3 or the second covering 7 therebetween. The exact construction and method of connection or point(s) of connection of the tubing 19 to the flume 1 is not considered critical. Desirably a pressure differential is created between the first chamber 9 and the second chamber 11. In this arrangement the greatest pressure is preferably but not essentially in the first chamber 9.

Typically, the under surface of the base part 3 i.e. the surface external of the first chamber 9, is configured for inhibiting heat radiation transfer from the first chamber 9. In one embodiment, this configuration is by colouring the under surface of the base part 3 a lighter colour than the colour of the heat absorbing surface that faces internally of the first chamber 9. Desirably, one such colour may be white. Another suitable colour may be silver. There may be other desirable colours but it should be noted that the colour is lighter in colour than the colour of the surface of the base part 3 that faces internally of the first chamber 9. The colouring of the respective surfaces of the base part 3 may be achieved by using a co-extrusion process for manufacture of the sheet material of the base part 3. This is a known technique and does not form part of any inventive concept herein. Alternatively, the base part 3 can be made of an upper sheet of black plastics material and a separate lower sheet of say white coloured plastics material.

As can be appreciated from the above, the collector flume, being manufactured from inexpensive plastics material sheet will provide a significant surface area of coverage for very little cost compared to the cost of conventional solar heaters. Typically, the flume can be manufactured in strip like form and cut to any desired length. The cut ends can be suitably closed as explained previously.

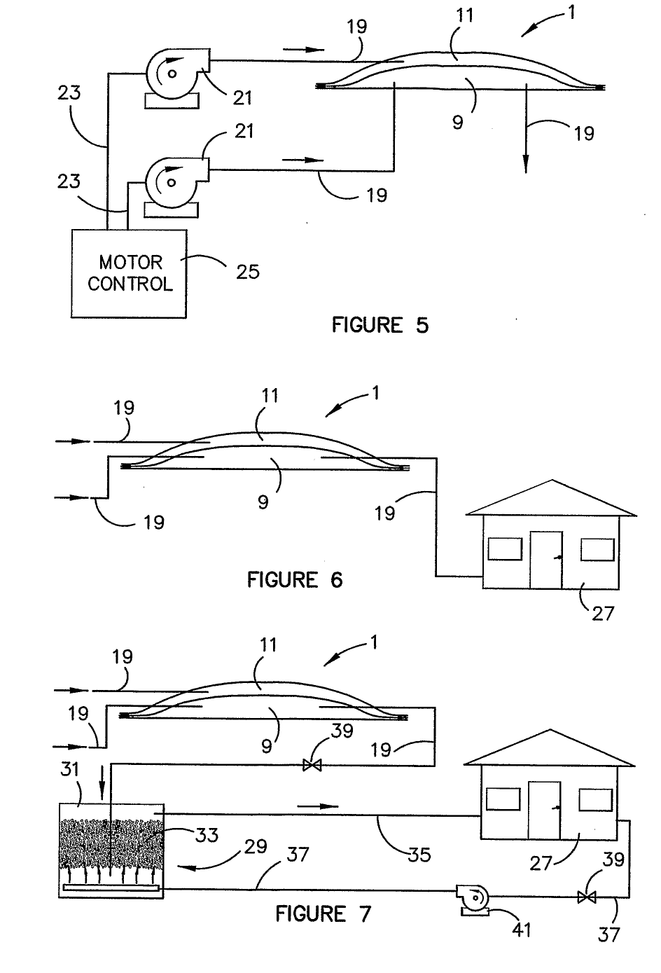

The air that is pumped into the first chamber 9 and second chamber 11 is typically air from atmosphere. Typically, air will be pumped into the first chamber 9 and the second chamber 11 with a pressure differential therebetween so that there is inflation of the flume according to the configuration shown in FIGS. 1 through 4. In one embodiment it is contemplated that air is pumped into just the second chamber 11 however it is preferred to pump air into both the first chamber 9 and the second chamber 11. The air in the second chamber 11 then acts as a heat insulating medium relative to external atmosphere for air in the first chamber 9. This allows solar energy to be collected into the air in the first chamber 9 by the solar energy passing though the air in the second chamber 11 and heating the black base part 3. The air in the first chamber 9 is then heated by heat exchange with the base part 3. Some minor heating of the air in the chamber 9 may also occur as solar energy passes towards the base part 3 through the first covering 5 Referring now to FIG. 5 there is shown a schematic diagram of one typical installation using the collector flume 1. Each of the first chamber 9 and second chamber 11 are preferably inflated by a respective air pump 21. Each of the air pumps 21 is an electrically driven air pump. Electric power for the motors of the air pumps 21 can be derived from a solar photovoltaic cell and a suitable electrical connection. The power is fed to the electric motors of the air pumps 21 along electric leads 23. The leads, in turn, are connected with a motor control circuit 25 which can be used to switch ON and OFF the respective air pumps 21 in response to daylight/night time conditions, and/or a thermal sensor element (not shown) that senses if the output air through output tubing 19 is above a certain required temperature. In this way, the motor control circuit 25 can be used as a crude form of temperature control of the output air. Additionally, the photovoltaic cell is a crude form of temperature control because if the incident solar energy falls below a certain level, the voltage output of the cell falls to a level insufficient to drive the air pumps 21, and thus, air is no longer supplied from the first chamber 9 into the building. The electric power solar collector panels have not been shown in FIG. 5 but typically connects with the motor control circuit 25 in a known manner. Alternatively, instead of using electric solar power collector panels to provide the power source for driving the electric motors of the air pumps 21, mains electrical power may be utilised or any other source of energy may be utilised. Depending on the volume of air provided by the air pumps, and the volume of the first chamber 9 and second chamber 11, and any air leaks in the chambers 9 and 11, two or more air pumps may be used to inflate respective chambers. The end requirement is to maintain the flume 1 in an inflated condition as shown. Desirably the capacity of the solar voltaic cells should be sufficient to maintain the air pumps operable in overcast or cloudy conditions. If desired the solar voltaic cells may be used to charge batteries, to enhance the air pumps operation during overcast or cloudy conditions.

FIG. 6 shows how the air that is heated by the flume 1 is directed out of the flume 1 from the first chamber 9 and into an area where the heated air is required. The heated air may be directly outputted from the flume 1 to a building 27. The building 27 may be a domestic house, an office building, a warehouse, a farm barn, a hot house or any other desired building in which heated air input is required.

FIG. 7 shows an alternative arrangement to that in FIG. 6 where the heated air is supplied to a heat storage bank 29 before being passed into the building 27. The heat storage bank 29 may typically comprise an enclosed chamber 31 in which the heat storage medium is crushed rock 33. In the example diagrammatically shown in FIG. 7, the heated air is passed to the bottom of the chamber 31 and filters upwardly through the heat exchange medium 33 transferring heat thereto. The air that escapes from the top of the heat exchange medium 33 then passes through passageway 35 into the building 27. Thus, during daylight hours when the collector flume 1 is collecting heat, the air passes into the heat storage bank 29 and transfers heat to the heat storage medium 33. The air then passes through passageway 35 into the building and heats the building. A return passageway 37 returns cooled air from the building 27 back to the heat storage bank 29. Non-return valves 39 may be provided in the tubing 19 or in the passageways 35 and 37 to inhibit unitended return flow of air. The non-return valves 39 may be simple flap valves or other known control valves. A circulating pump 41 is provided in the passageway 37 to assist the flow of return air into the heat storage bank 29.

In night time conditions or low solar energy conditions, the solar fluid flume 1 will not be collecting significant solar energy. In many instances, the air that is passing through passageway 19 into the heat storage bank 29 will be of a lower temperature than the residual temperature of the heat storage medium 33 therein.

Accordingly, under these conditions, the collector flume 1 may be collapsed by turning off the pumps 21. The non-return valve 39 will then inhibit any airflow from returning into the flume 1. The pump 41 can be supplied with driving power such as from mains power, to circulate the air through the passageways 35 and 37 and through the heat storage medium 33 in the heat storage bank 29. In this way, the heat stored in the heat storage medium 33 can be recovered and delivered to the building 27. The pump 41 can be controlled by use of an electrical thermostat to control whether the pump is ON or OFF or to control the volume of air flow. In this way, crude control of the temperature within the building can be achieved. Instead of the heat bank being a crushed rock type heat bank, it may any other suitable heat bank. A water storage heat bank will be described in the following description.

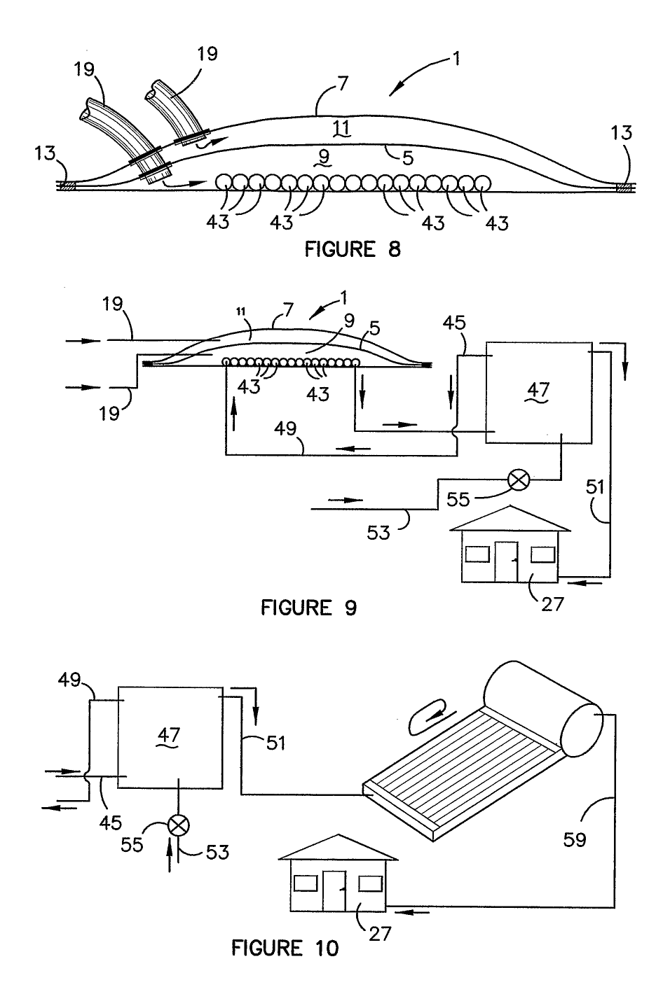

Referring now to the embodiment of FIG. 8 it can be seen that there is provided a collector flume 1 of similar construction to that shown in the preceding figures. Accordingly, like integers have been shown with the same numerical designations. In this embodiment, the first chamber 9 contains a series of heat collecting passageways 43. The passageways 43 are solar water heating passageways such as swimming pool solar collector passageways and may conveniently comprise parallel extending strips of black P.V.C. tube, or other known dedicated extruded spaghetti like tube for swimming pool solar water heating use. In this case, the passageways 43 are arranged to extend along the longitudinal extent of the flume 1 from one end to the other. Typically, the passageways 43 may be interconnected with appropriate header tanks at each of the distant ends in a known manner. Alternatively, the individual passageways 43 may be serially interconnected. In use, the passageways 43 are arranged to carry water therein. Thus, water within the passageways 43 is heated in the first chamber 9.

This occurs primarily by solar energy transferring into the tubing directly or by also transferring into the black base part 3 and then into the tubing by convection from the base part 3. As the water is heated it expands and creates its own means of water flow so heated water can be outputted. A pump (not shown) may be utilized to assist the flow. In addition an inlet end for cold water may be placed at a lower height than an output end for heated water, such as by placing the flume on a slope. In this way the slope, and the heated water, will assist the water flow though the water heater passageways.

The outputted heated water may then be fed into a hot water heat storage bank where the heated water itself is the heat storage medium.

In one test example of a collector arrangement as shown in FIG. 8, conducted in Victoria, Australia in June 2004, significant heat collection has been obtained. For a collector arrangement of approximately 1 meter in width by 100 meters in length and having the arrangement as shown in FIG. 8, on a day with ambient air at 15° C., and the input temperature of water into the passageways 43 of 20° C., the output water temperature has reached 40° C. at a flow rate of approximately 150 liters per hour. Given that the solar energy received in Victoria in June is annually at its lowest, the results are significant and show that for a collector of the type shown, sufficient hot water can be collected for a domestic hot water environment without the need for supplemental energy input.

FIG. 9 shows a schematic arrangement utilising the flume construction shown in FIG. 8. In this version, the first chamber 9 and second chamber 11 are inflated and pressurized by atmospheric air pumps similar to the pumps 21 in previous embodiments. Each of the first chamber 9 and second chamber 11 may be closed so that air cannot escape therefrom. Thus, in this situation, the pumps 21 will maintain the chambers 9 and 11 fully inflated without escape of air therefrom. The flume 1 will then cause air in the first chamber 9 to be heated by solar energy and the heated air will also assist transfer of the heat content through the passageways 43 and into the water contained therein. The heated water may then pass out of the flume 1 via water passageway circuit 45 and into a hot water storage tank 47. A return passageway 49 is provided to return cooled water back into the flume 1 and into the passageways 43. Heated water may pass through passageway 51 into a building 27. The heated water may be used to heat heater panels within the building so the building may be heated thereby, or alternatively the heated water may pass into the building 27 through passageway 51 as the normal hot water supply for the building 27. A mains supply of water may be introduced into the system through passageway 53, and suitable non-return valve 55.

Referring now of FIG. 10 there is shown a variation of the example shown in FIG. 9. Here, the passageway 51 provides hot water from the hot water tank 47 to a conventional solar hot water heating unit 57. The heated water that is supplied along passageway 51 is therefore preheated water for the hot water heating unit 57. This will improve the efficiency of the hot water heating unit 57. Any known hot water heating unit 57 may be utilised for this purpose such an electric powered hot water heating unit, a gas or oil powered heating unit, and the use of a solar hot water heating unit is not essential. Water can then be outputted from the hot water heating unit 57 along passageway 59 and into the building 27. By utilising an arrangement as shown in FIG. 10 high temperatures of the water may be achieved for relatively small economical outlay and the flume provides heated fluid to supplement the heat provided by the conventional heating unit 57. In this case, a smaller conventional hot water heating unit 57 may be utilised, and given that the collector flume 1 is comparatively much less expensive than a conventional hot water heating unit 57, running or operating costs for a given temperature of water output can be minimised.

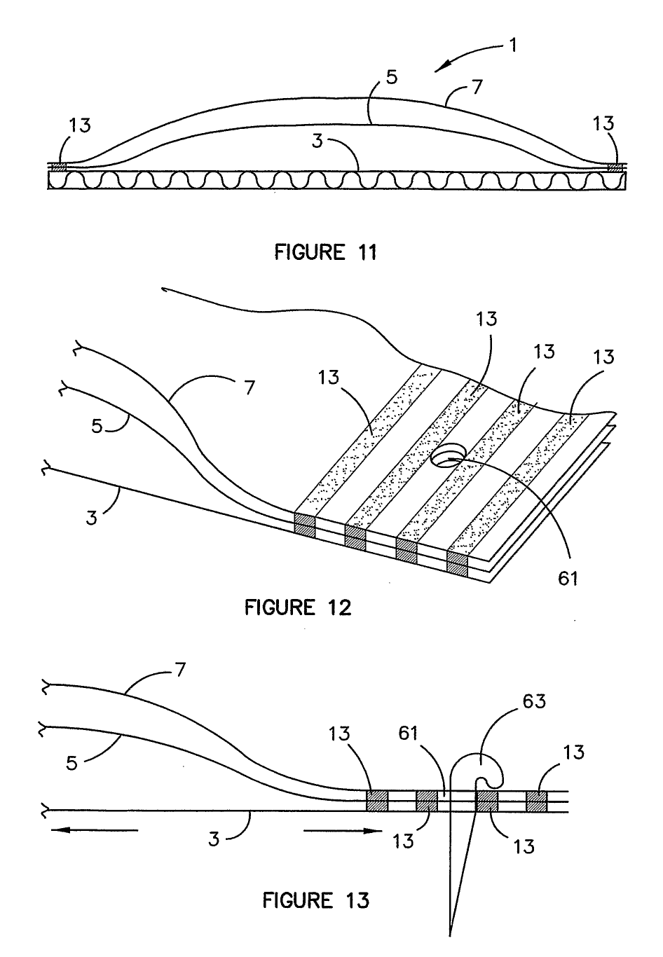

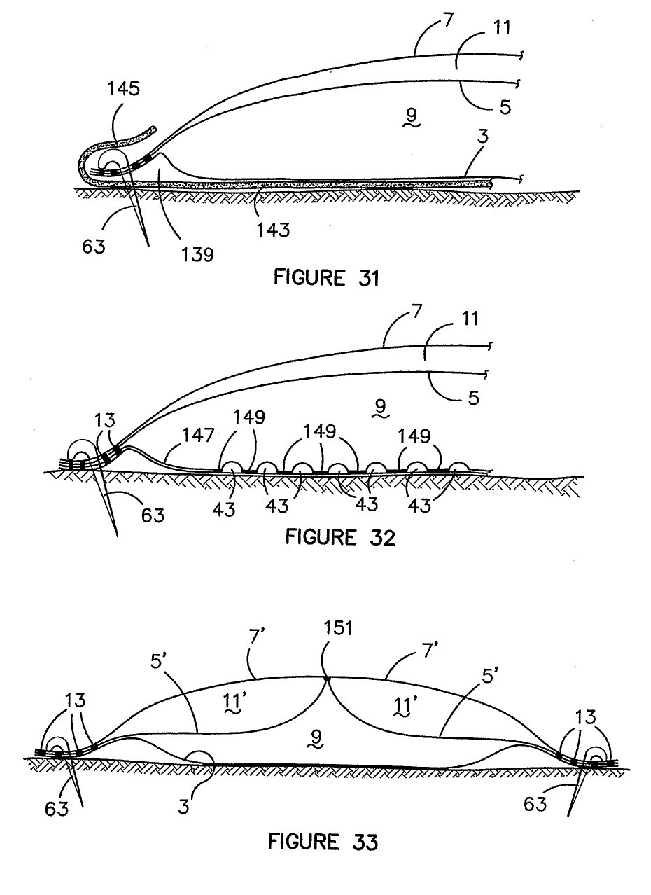

Referring now to the embodiment of FIG. 11 it should be appreciated that the flume 1 is of similar construction to that shown in the previous example of FIGS. 1 through 4. Here, however, the base part is made relatively rigid compared to the first covering 5 or the second covering 7. In addition, the base part 3 is made thermally insulating and of substantially higher thermal conductivity insulation property to that of the first covering 5 or second covering 7. Thus, by using a rigid and thermally insulating material, heat loss transfer to the outside environment of the flume 1 can be minimised. FIG. 11 shows a corrugated plastics material sheet structure having upper and lower faces with an internal corrugated membrane. Such sheet structures are well known in plastics sheet arts. The plastics material is such that the seal 13 can be effectively made relative to the base itself and the coverings thereby holding the insulation to the flume 1. In other examples (for example as shown in FIG. 31) a foam like arrangement may be provided on the under surface of the base part 3 to provide the necessary thermal conductivity insulating properties. It is desirable that the material for providing the higher thermal conductivity insulating properties for the base part 3, not be water absorbent as it has been found that if the thermal insulating material is water absorbent, any absorbed water acts as a heat thermal conductive medium and the efficiency of the thermal insulating property is reduced. This is particularly important if the flume 1 is to be laid on a ground surface such as a field where water drainage may be an issue. Some suitable products for the thermal insulating material are “bubble pack”, or recovered plastics from plastic bags which is then foamed into a sheet. This latter product is known in Australia by the name “cell Air”, and may typically be about 9 mm in thickness.

Referring now to FIG. 12 there is shown the way in which one form of edge sealing is performed to the flume 1. Here, four parallel rows of sealing strips are provided along the side edges of the flume 1. The bonding may be a thermal bonding welding process using known technology such as R. F. technology or by other known bonding or sealing arrangements. Thus, the base 3, first covering 5, and second covering 7 are bonded relative to the base 3 by four parallel strips on each side of the flume 1. A hole 61 may be pre-made or punched through the side edges of the flume 1 between the strips of the seal 13. This hole 61 may be applied at regular intervals such as of 1 m to 2 m along the length of the flume 1. Thus, the holes 61 provide position fastening means to enable fasteners such as fastening pegs 63—see FIG. 13—to anchor the flume 1 to a supporting surface for the flume 1, such as to the ground or to a roof of a building. FIG. 13 also shows that the base 3 is stretched across its sides by the use of the fastening pegs 63 along each of the side edges. Thus, by applying stretching tension across the base 3, the base 3 can be held to the supporting surface. This, in turn, ensures that the first covering 5 and second covering 7 are inflated above the base 3 without the base 3 inflating substantially relative to its planar condition and lifting the side edges upwardly a substantial distance from the supporting surface.

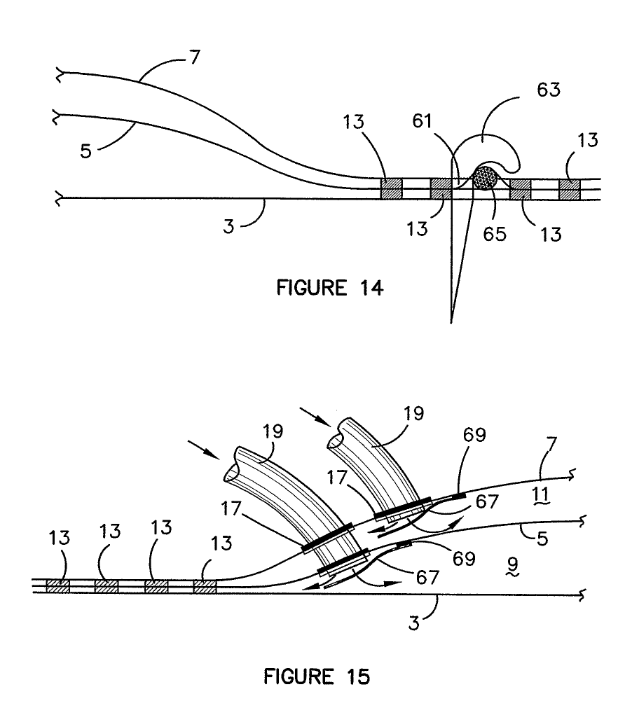

FIG. 14 shows a variation of the sealing shown in FIG. 13. Here, a strip 65 is fixed between adjacent seals 13. Typically, this strip 65 may be a plastics material cord or any other convenient like medium such as a bailing twine or rope or strip similar to a sail batten. The strips may even be of wood or metal. The strip 65 may be fitted between one or other of the first covering 5 or second covering 7 and the base 3. In this way, when the peg 63 is fitted through the opening 61, the strip 65 will locate under the head of the peg and help to retain the side edges of the flume 1 suitably restrained against inward movement. This, in turn, maintains the base 3 in a substantially flat and planar condition on the supporting surface. In the case of using sail type battens, they assist in maintaining the flume in an elongate flat planar arrangement as well.

FIG. 15 shows a flap valve arrangement for sealing the tubing 19 against reverse air flow that may be occasioned if the pumps 21 stop operating due to lack of sufficient electrical voltage collected by solar cell power supplies. This may be occasioned early in the morning or late in the evening when the solar energy is at its minimum, or on overcast days. In this arrangement, the flap valves 67 comprise sheets of similar material to the first covering 5 or second covering 7. These sheets are welded to the flume as shown by welds 69 to the first covering 5 and the second covering 7.

Whilst flap valves have been shown, other non-return valves types may be incorporated. A flap valve of the type shown is very inexpensive compared to other known non-return valves. In this case, the non-return valves 67 overlays the tubing 19 to inhibit reverse airflow.

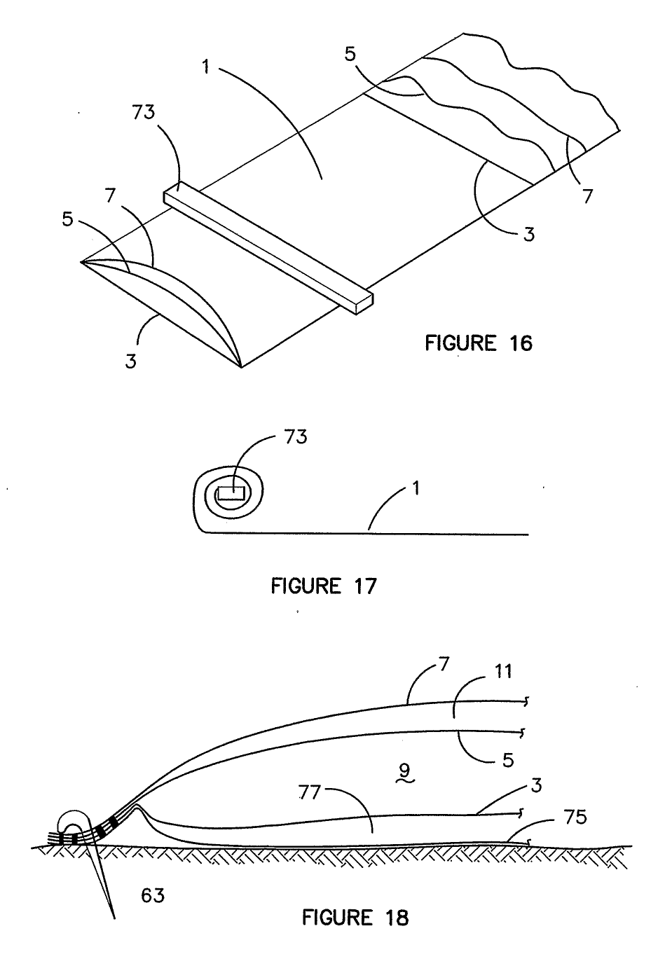

Referring now to FIGS. 16 and 17 there is shown an alternative arrangement for closing the ends of the cut flume 1. The cut end is rolled to effect closing. In this arrangement, a strip of wood 73 or of any other convenient material is placed to span across the width of the flume 1. The end of the flume is then placed onto the strip 73 and tightly wound several turns. This, in turn, rolls up the end as shown in FIG. 17. Clips such as bulldog clips or similar can be used to then clamp the rolled end in position. The opposite end of the flume can be sealed in the same way if required. This arrangement avoids the need for directly sealing the individual webs 3, 5 and 7 to one another to effect closing.

An alternative form of closing the ends of the flume 1 is to provide mating ““Velcro”” hook fasteners on overlapping edge surfaces. Further, plastic zips can be provided pre-moulded into the cut ends. A suitable tool may be utilized to form the zip fasteners on cut ends. Other forms of closing the ends may be incorporated.

In addition, the flume 1 may be made in lengths of several meters rather than of a substantially continuous length, and the individual lengths interconnected by similar “Velcro” hook fasteners, or zips to produce a continuous collector 1 of the required length.

Referring now to the embodiment of FIG. 18 it should be appreciated that this is similar to the embodiment shown in FIGS. 1 through 4 but here, there is a plastics material sheet third covering 75 placed under the base part 3. The third covering 75 is welded to the side edges of the flume 1 at the edge seals 13. The third covering 75 therefore provides a third chamber 77 between the third covering 75 and the under surface of the base 3. The third chamber 77 can be inflated in a similar manner to that for either the first chamber 9 or the second chamber 11 thus lifting the base 3 off the ground surface. The third chamber 77 therefore provides an insulation for the under surface of the first chamber 9.

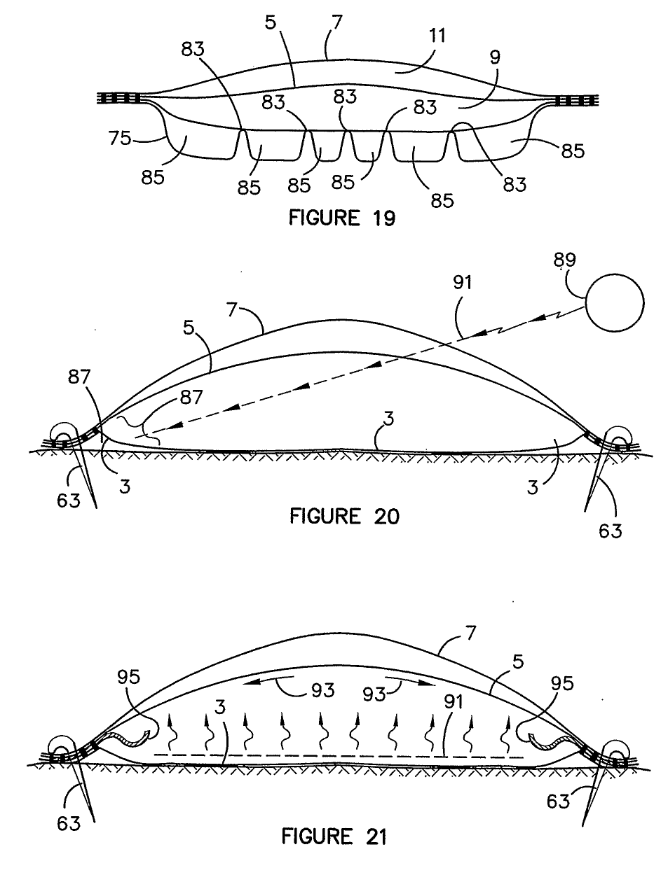

Referring now to FIG. 19 there is shown an embodiment similar to that of FIG. 18 but here, the third covering 75 is looped upwardly and bonded at discreet longitudinal bonding lines to the under surface of the base part 3. The bonding lines have been shown diagrammatically at points 83. Breaks may be provided along the longitudinal extent of the bonding lines 3 to allow air passageways between the chambers 85 that are created. In this case, the third chamber 77 is comprised of a plurality of sub chambers 85 with interconnected air passageways therebetween. Thus, by inflating the third chamber 77, through one of the sub chambers 85, air can be caused to pass into all of the sub chambers 85, thus inflating them. This arrangement provides lateral and longitudinal rigidity to the flume 1. The flume 1 can be anchored to the ground in a manner similar to that shown in FIG. 18. The means of mounting/locating the flume 1 relative to the ground has not been shown in FIG. 19 in order to avoid cluttering the figure itself.

FIG. 20 shows an alternative embodiment to the embodiment shown in FIGS. 1 through 4. Here, the base part 3 is allowed to expand upwardly in the opposite direction to the expansion of the first covering 5. By allowing the base part 3 to expand upwardly and not be maintained substantially planar there are provided upturned sides to the base part 3. The upturned sides have been shown by numerical designation 87. In this arrangement, the longitudinal axis of the flume 1 is orientated generally north-south, although this is not critical. Thus, when the sun 89 is rising or falling, such as early in the morning or late in the evening, as diagrammatically shown in FIG. 20, the upturned sides 87 will be substantially normal to the incident solar energy transmitted from the sun. This is diagrammatically shown by solar ray line 91. Thus, in this condition, at extremes of early morning or late in the evening, the solar collector can perform better than the collector arrangement shown in FIGS. 1 through 4.

Referring now to FIG. 21 there is shown an alternative use for the collector flume 1. Here, the arrangement is similar to any one of the preceding embodiments, except, however the particular embodiment of FIG. 20 has been shown. In this embodiment, the flume 1 is used for an additional purpose being to collect drinking/potable water from water that is otherwise not drinkable. This water may be salt water, bore water, waste water, or any other similar type of water where drinking water can be recovered by evaporation of the water and the subsequent condensation of the evaporation back into fresh water. FIG. 21 shows that a layer of water 91 is distributed over the base part 3. The depth of the water should be as shallow as possible whilst still maintaining a substantially complete covering of a major part of the base part 3. In this arrangement it allows for the layer of water 91 to be evaporated and the evaporated water to collect/condense on the under surface of the first covering 5. Because the first covering 5 is upwardly domed, the collected/condensed water is able to move by gravity, as shown by the arrows 93, to the side edges of the flume 1. The water that is moved to the side edges of the flume 1 is then collected in gutters 95 that are sealed into the flume 1 during sealing of the base part 3, first covering 5, and second covering 9. The gutters 9 are typically plastics material extrusions that run the length of the flume 1. The gutters 95 are typically of greater rigidity than the rigidity of the first covering 5 or second covering 7 or the base part 3. Thus, the gutters 95 are substantially self supporting and be retained in the positions shown in FIG. 21, even when water is collected within the gutters 95.

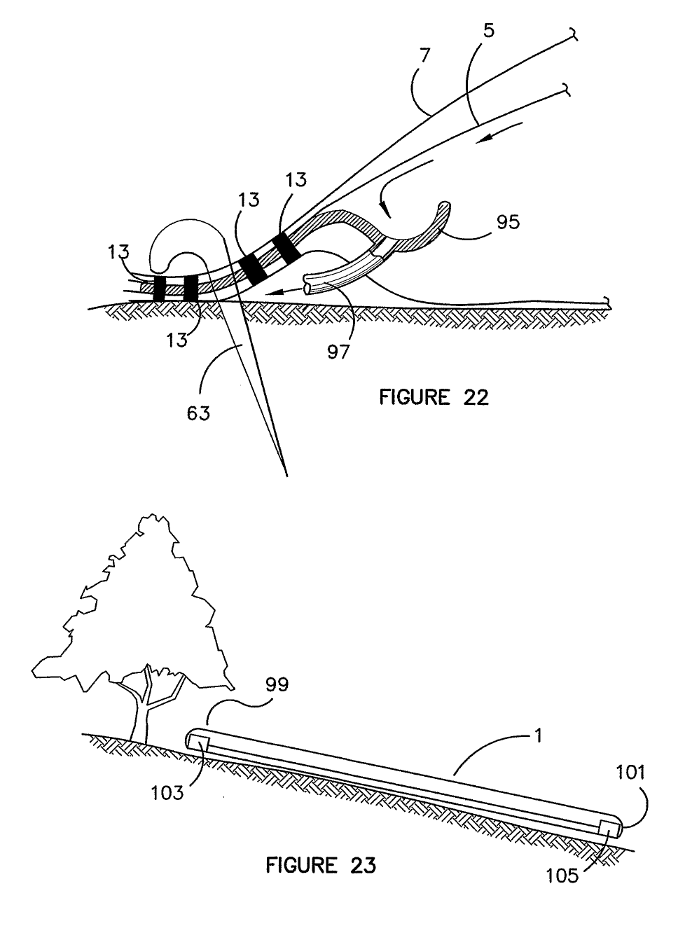

FIG. 22 shows a close-up side edge view of the arrangement shown in FIG. 21. FIG. 22 also shows how plastics material tubing 97 is fitted to the lowermost regions of the gutters 95 at various locations along the longitudinal extent of the gutters 95. Thus, the tubing 97 allows water collected in the gutters 95 to drain from the gutters 95 and be collected in a suitable collection tank. The air pressure within the first chamber 9 provides a pressure differential to the outside atmospheric air, and this pressure differential causes the collected water to pass through the tubing under pressure.

FIG. 23 is a side elevation view of a typical arrangement incorporating the water recovery concept shown in FIGS. 21 and 22. Here, the flume 1 is supported on an inclined ground surface. Thus, there is a top end 99 of the flume 1 and a bottom end 101. A header distribution tank 103 is provided at the top end 99. The water which is to be placed onto the base 3 to form the layer of water 91 is introduced into the header distribution tank 103 and allowed to pass therefrom by gravity to flow along the longitudinal extent of the flume 1 as a layer of water 91. As the water flows downhill, it is then collected in a collection trough 105 at the bottom end 101 of the flume 1. Water in the collection trough 105 may be re-circulated to the header distribution tank 103 with a suitable pump. The pump may powered by solar electricity collected from a suitable solar voltaic cell.

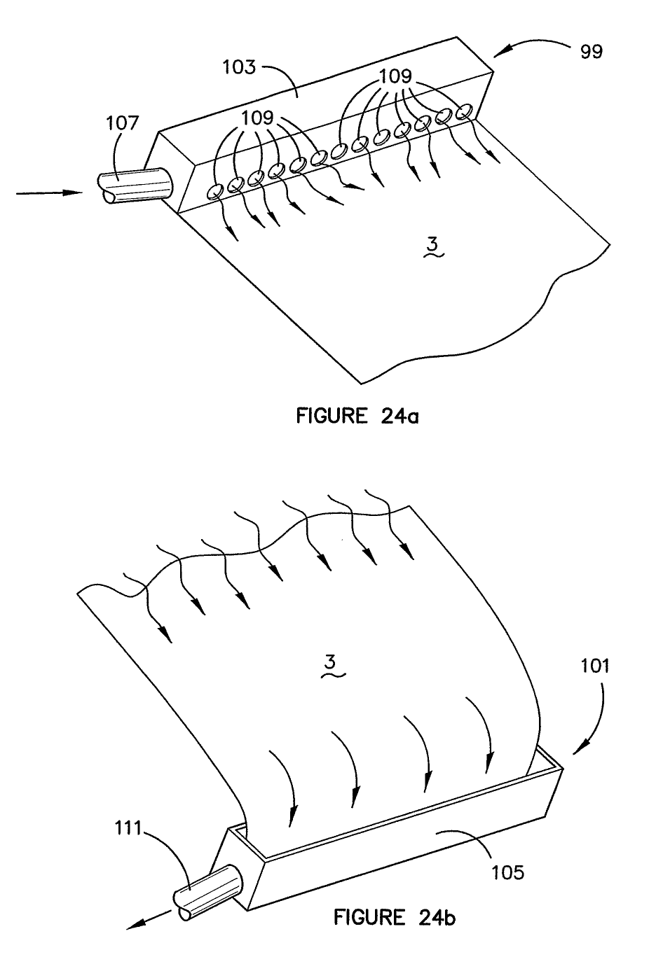

FIGS. 24a and 24b show the particular arrangement of the header distribution tank 103 and the collection trough 105. Here, water is introduced into the header distribution tank 103 through water passageway 107. The header distribution tank 103 has a series of fine openings 109 from which water can pass so that it is distributed generally evenly across the base part 3 to form the layer of water 91. Layer 91 has not been shown in FIG. 24 in order to add clarity. As the water passes down the base part 3 from the top end 99 to the bottom end 101 it evaporates because of the heat of the air within the first chamber 9. Any non-evaporated water that reaches the bottom end 101 passes into the trough 105 and is returned through water passageway 111.

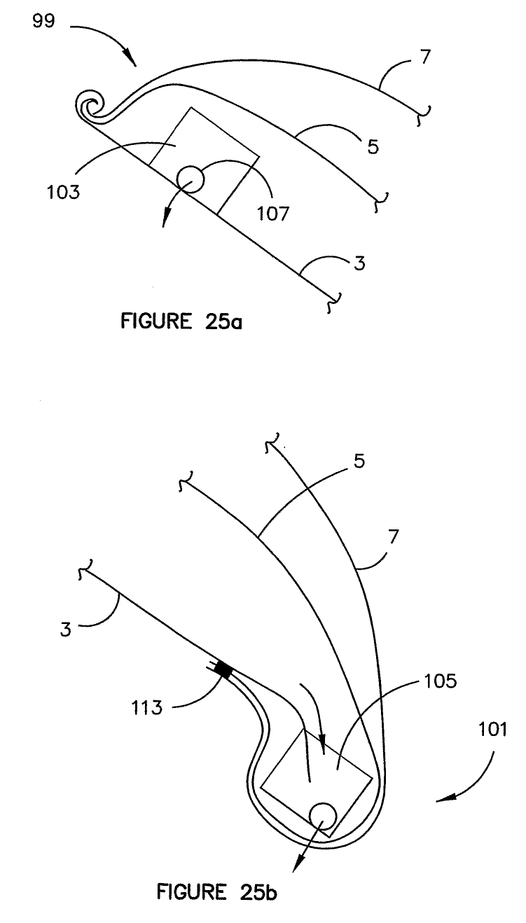

FIGS. 25a and 25b show the way of closing the top end 99, and the bottom end 101 of the flume. FIG. 25a shows how the end is rolled closed in a manner similar to that shown in FIGS. 16 and 17. Once rolled it can be clipped to hold it in the closed conditions. Thus, the header distribution tank 103 is maintained between the upper surface of the base part 3 and the under surface of the first covering 5.

FIG. 25b shows how the base part 3 is fed into the trough 105. The base part may need to be trimmed in shape at each side edge to enable fitting into the trough 105. The first covering 5 and second covering 7 are then folded over the bottom end 101 and suitably sealed to each other and to the under surface of the base part 33 by a suitable sealing means such as double sided adhesive 113.

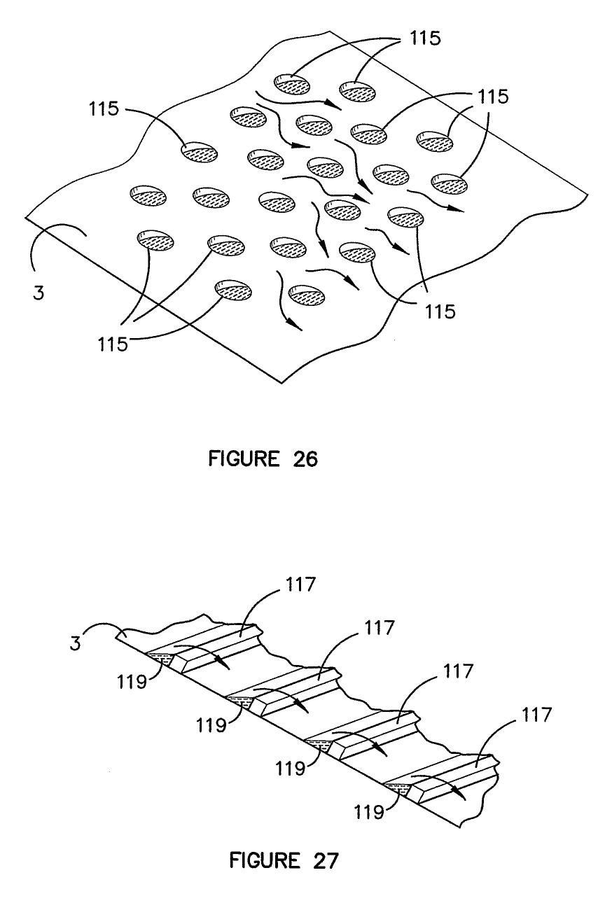

FIG. 26 shows one means of attempting to uniformly distribute the layer of water 91 over the base part 3. Here, indentations 115 are pre-formed into the surface of the base part 3. The indentations may be formed by a roller that is heated and thermally forms the indentations 115 into the sheet material of the base part 3. Thus, the indentations 115 cause shallow pools of water to form on the base part 3. Thus, as the water flows in the layer 91 it will collect in the indentations 115 and inhibit the flow rate of the water along the length of the flume 1 from the top end 99 to the bottom end 101. This therefore provides liquid flow control restraining means and provides for greater time exposure of the water to the heat within the first chamber 9 and assists in the evaporation of the water. Whilst indentations 115 have been shown, upstanding shallow protrusions in the form of semi hemispherical domes can also be provided. This will direct the water on either side of the domes over the upper face of the base part 3. The domes are placed at similar positions to the indentations 115 as shown. Thus, the domes will also assist in limiting the flow rate of the water along the length of the flume 1 and provide liquid flow control restraining means. If desired, a combination of indentations 115 and protrusions may be utilized.

In a further variation an absorbent cloth may be laid over the top of the base part 3. The cloth will therefore slow the flow of liquid along the length of the flume. The fibres/filaments of the cloth will also assist in providing enhanced exposure of the liquid to solar energy absorption. The cloth may be black coloured to further assist solar energy transfer to the liquid. A geotextile cloth is a very suitable cloth for this purpose.

Referring now to FIG. 27 there is shown an alternative arrangement for limiting the flow rate of the water layer 91 over the base part 3. Here, ribs 117 are provided across the face of the base part 3. The ribs 117 can be bonded to the upper face of the base part 3 by a suitable bonding process. The ribs 117 provide weir walls for the flow of water and therefore provide an accumulation of water behind the weir walls as shown diagrammatically by numeral 119. The ribs 119 may be arranged to extend either wholly or partly transversely across the flume 1 from side to side. FIG. 27 diagrammatically shows how the water builds up behind the weir walls and overflows and then accumulates against the next wall. This arrangement minimizes the flow rate of the water layer 91 from the top end 99 to the bottom end 101. Other arrangements may be utilized to minimize the flow rate of the water layer 91 without departing from the nature of the invention in this embodiment.

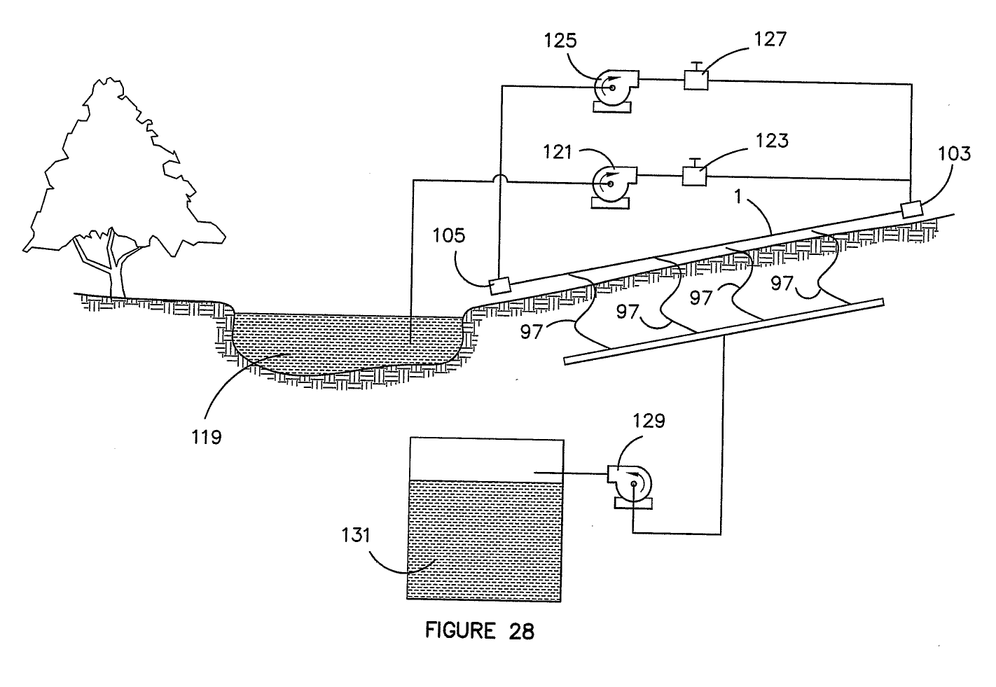

FIG. 28 shows diagrammatically the water circuit for the arrangement shown in FIGS. 21 through 27. Here, there is a source of water 119 that needs to be evaporated by the collector flume 1 to form drinking/potable water. The water is pumped to the header distribution tank 103 by a pump 121. A suitable control valve 123 may be used to control the flow rate. The pump 121 may be powered by an electrical solar voltaic cell. The water that forms layer 91 collects in the collection through 105 and is pumped therefrom via a further electric solar powered pump 125. A control valve 127 is provided to limit the flow rate. Thus, water is introduced into the flume 1 from the source of water 119 and is circulated within the flume 1 by pump 125. As the evaporated water condenses it is collected through the tubing 97 and pump via pump 129 into a storage tank 131.

Periodically, the flume 1 will need to be opened for flushing to remove any deposits which may accumulate within the flume 1 as a result of the evaporation process. By utilizing the sealing method outlined in FIGS. 25a and 25b, the ends of the flume 1 can be suitably opened and resealed without undue difficulty. The header distribution tank 103 and the collection trough 105 may also need to be periodically flushed to remove any unnecessary deposits.

Whilst the above embodiment is particularly suited for collecting drinking/potable water, a similar process may be invoked to recover minerals or other deposits from a known liquid that contains such minerals or deposits. Thus, periodically, the flume 1 can be open so that the valuable minerals/deposits that have accumulated therein can be collected. Thus, the above described process provides an economical form for recovery of those valuable minerals/deposits.

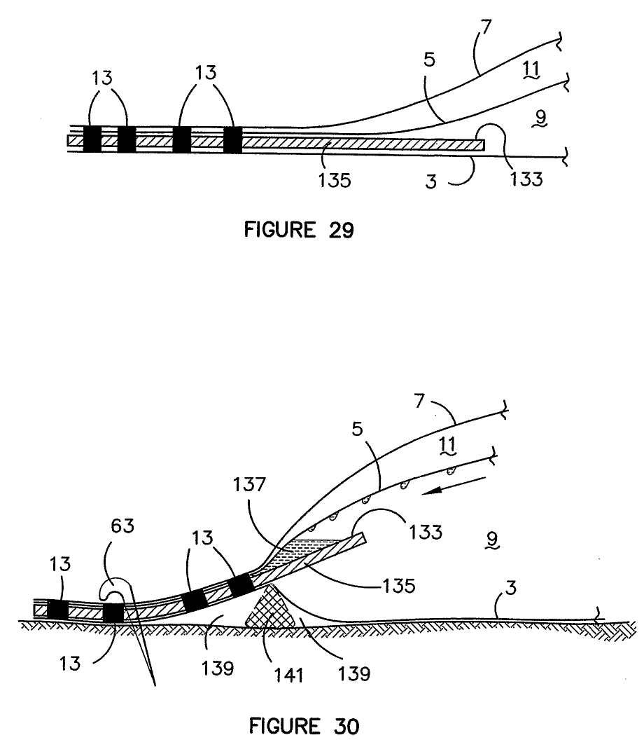

FIGS. 29 and 30 show an alternative arrangement to the gutters 95 in the previous embodiment. Here, a collection surface 133 is provided by means of a semi-rigid plastics material strip 135. The strip 135 is bonded to the base part 3 and the first covering 5 and second covering 7 during the sealing process along seal 13. An identical strip 135 may be provided at the opposite side edge of the flume 1. FIG. 30 shows how the strip 135 provides an upwardly inclined collection surface 133 to form a small reservoir 137 of collected water or liquid. In this embodiment, the inflation of the first chamber 9 causes the base part 3 to be lifted upwardly at the side edges along the seal region 13. Thus, a pocket or airspace 139 is provided longitudinally along each of the side edges of the collector 1. This, in turn, causes the substantially rigid plastics material strip 135 to incline upwardly from the peg 63 fastening position. Thus, as the liquid drains from the under surface of the first covering 5 and onto the collection surface 133 it forms a reservoir 137. The water or other liquid that forms in the reservoir 137 can be drained from the collector 1 in a manner similar to that shown in the previous embodiment using the tubing 197 that connects into the bottom on lowermost edge of the reservoir 137. The tubing may be arranged to pass from the base part 3 through the strip 135, or alternatively through the second covering 7 and the first covering 5. In a further embodiment, when the collector is on a sloping surface, the liquid in the reservoir 137 may run to the bottom end of the collector 1 and be collected therefrom in a suitable collection trough or gutter.

FIG. 30 shows the addition of a support 141 in the form of a triangular transverse cross section strip which is manually placed at the side edges of the collector 1 to hold the strip 135 in the upwardly inclined position as shown. Whilst a triangular cross section support 141 is shown, other cross sectional shape supports may be utilized.

Referring now to FIG. 31 there is shown close-up detail of an embodiment similar to that shown in FIG. 30, but wherein a thermal insulating ground sheet 143 is provided under the collector 1. The ground sheet 143 may run the length of the collector 1 or may be in shorter lengths which overlap. In this example the width of the ground sheet 143 is slightly wider than the width of the collector 1. Thus, side edges 145 of the ground sheet 143 can be folded over the top of the side edges of the collector as shown and then suitably held in place by an adhesive bonding medium (not shown) or by other fastening means such as “Velcro” hook fastener tapes that are held to the ground sheet 143 and the collector 1 in a suitable manner. Desirably the peg 63 punctures the ground sheet 143 and maintains the ground sheet in position under the collector 1. The ground sheet 143 may be made of any suitable thermally insulating material. It has been found that “bubble pack” is an extremely good ground sheet 143. Similarly, “cell air” is another desirable thermally insulating ground sheet 143. Foam sheet of approximately 5 cm thickness is also suitable. The ground sheet 143 then provides thermal insulation to the collector from the ground itself, and also as the folded over side edges cover the air space 139, it minimizes heat loss through the air space 139. The “bubble pack” or the “cell air” product may be coated on one face with a reflective coating to enhance thermal insulation. If desired, the ground sheet 143 may be a completely separate and non-interconnected sheet relative to the collector 1. In another embodiment, it may be formed integrally therewith.

FIG. 32 shows an embodiment similar to that in FIG. 8. In FIG. 32, rather than provide heat collecting passageways 43 in the form of known solar collector material such as that used in swimming pools, the heat collecting passageways 43 may be formed onto the base 3 by a second plastics material sheet covering 147. This covering is conveniently sealed at the side edges of the flume 1 along the seal 13. It is also sealed to the base 3 at longitudinally extending strips 149. Thus, the further covering 147 provides heat collecting passageways 43 with the base 3. If required, the covering 147 may be coloured black. In this embodiment the base 3 may be coloured white or some other reflective colour. Thus, the uppermost surface of the further covering 147 is of a heat absorbing colour to enhance heat absorption into water that is caused to flow within the heat collecting passageways 43.

Referring now to the embodiment shown in FIG. 33, it can be seen that it is very similar in conceptual form to the embodiment shown FIGS. 1-3. In this embodiment, each of the flexible sheet coverings are of substantially identical width. Thus, in this embodiment, there is a base part 3 which may be say, 1 meter in width. There is a plastics material sheet first covering 5′ and a further first covering 5′ each of 1 meter in width. The first of the first covering 5′ is connected at one side of the flume, whilst the other first covering 5′ is connected at the opposite side of the flume. A second covering 7′ overlies the first covering 5′, and a further second covering 7′ overlies the second first covering 5′. Each covering 7′ is of 1 meter in width. Each of the second covering 71 is connected at the respective side edges of the flume 1 along the former described seal 13. The other ends of the first coverings 5′ and second coverings 71 are connected at a seal 151 generally centrally and longitudinally of the flume. Thus, in this embodiment, as each of the base part 3, first coverings 5′, and second coverings 7′, are of equal width, it provides for economical use of plastics material and provides a configuration to the collector in the form as shown. The seal at 151 may be a single seal or multiple seals.

Whilst the thermal insulation properties of the second chamber 11′ will be less than the thermal insulation properties of the second chamber 11 shown in the embodiment of FIGS. 1-3, because there is less air space underneath the seal 151 for insulating the first chamber 9, the heat loss component is minimal.

Thus, the embodiment shown in FIG. 33 provides for economical manufacture of the collector flume from sheet plastics material without any substantial wastage which may otherwise be required because of cutting to required widths in the example shown in FIG. 1-3.

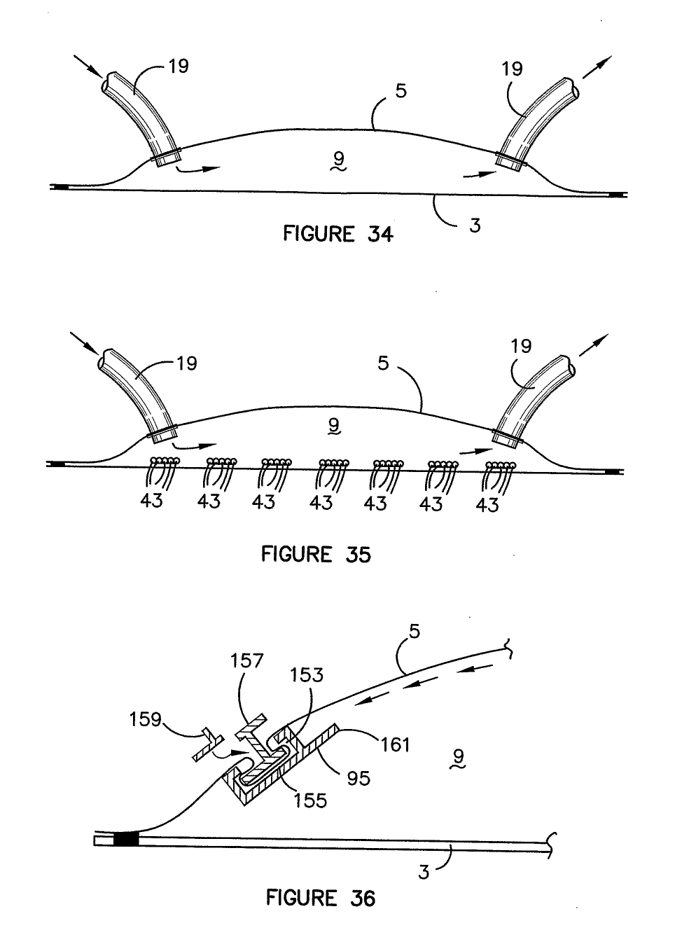

The embodiments shown in FIGS. 34-38 do not include a second chamber 11 as is shown in the preceding embodiments. Tests have shown that in certain climatic areas, the heat insulating property of the second chamber 11 can be dispensed with, whilst the solar collector has similar heat collecting properties. Accordingly, when ambient air temperature is about ±5° c. or higher, it has been found that a heat collector without the second air chamber 11 (i.e. without the second covering 7) provides extremely good heat collecting characteristics. Tests have shown that the second air chamber (i.e. with the second covering 7) is beneficial when the temperature drops below 5° c. such as in Alpine or other areas subjected to low ambient air temperatures including air temperatures below 0° c.

FIG. 34 shows an embodiment that has a base part 3 and a plastics material sheet first covering 5 (as in previous embodiments). The base 3 and the plastics material sheet first covering part 5 define a first air chamber 9. A positive air pressure supplier such as an air pump supplies ambient air into the chamber 9 through tubing 19. The sheet material of the base 3 and of the first covering 5 are of similar material to that in previous embodiments. Thus, the air under pressure inflates the solar flume 1. Air that is heated within the chamber 9 is passed out of chamber 9, in a controlled manner, through outlet tubing 19.

FIG. 35 shows a further embodiment similar to that in FIG. 34 that uses heat collecting passageways 43, in the form of swimming pool solar hot water heating strips. Water or liquid passed through the heat collecting passage ways 43 is heated within the first chamber 9 and can be taken from the solar flume and stored or used as a hot water source or a heat reservoir.

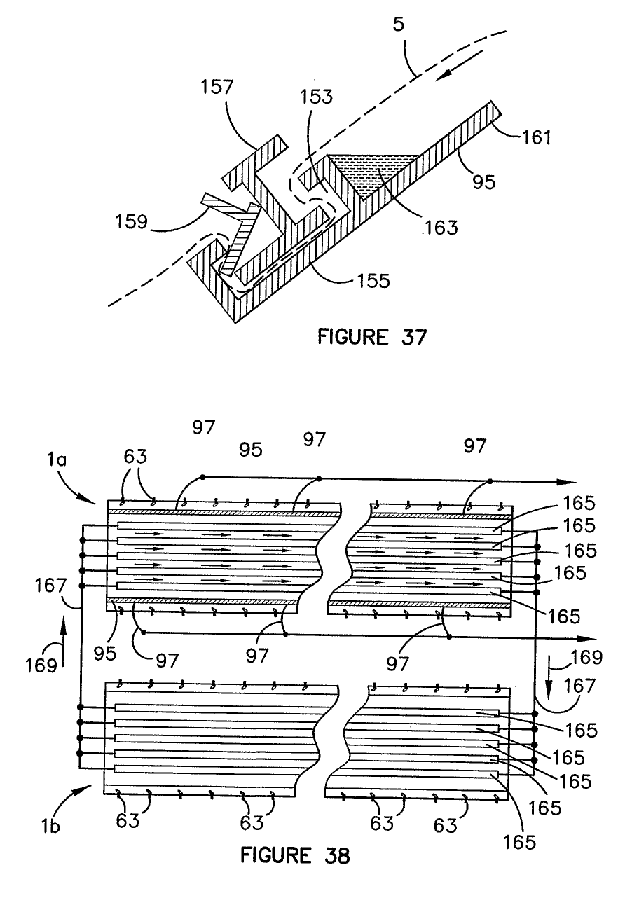

FIG. 36 shows an embodiment similar to that in FIGS. 21-30 for collecting drinkable/potable water from water that is otherwise not drinkable/potable but which can be converted to drinkable/potable water by evaporation and condensation. In this embodiment, the solar flume 1 does not have a second covering 7 and therefore does not have a second air chamber 11. Thus, the flume itself is similar to that shown in the embodiments in FIGS. 34 and 35. FIG. 36 shows a different form of guttering 95 relative to the guttering shown in the embodiments of FIGS. 21-30. Here, the guttering 95 is provided by utilizing a known mounting strip sold under the trade marks REDPAT™ and LOCKSTRIP™ that enables agricultural films and fabrics to be retained to structural surfaces. Here, the guttering 95 is formed from a three piece plastics material REDPATH LOCKSTRIP™ sold by Redpath Ideal Greenhouses Pty Ltd, Rohs Road, RSD 4, Bendigo East, Victoria 3539, Australia. FIG. 36 shows that the first covering 5 passes into a C shaped locking recess in a main body part 155. A retaining strip 157 then fits into the C shaped locking recess 153 on top of the first covering 5. A locking wedge 159 then fits partly within the C shaped locking recess 153 and a space provided by the retaining strip 157. The retaining wedge 159 then holds the retaining strip 157 in place and locks the gutter 95 relative to the first covering 5. The arrangement is more clearly shown in FIG. 37. An extending arm 161 of the base 155 then provides a liquid collection gutter where drinkable/potable liquids can accumulate at the bottom of the gutter as shown by numeral 163. The liquids in the gutter 163 therefore comprise the drinkable/potable water and can be taken out of the solar flume 1 in a manner similar to that disclosed in the embodiments shown in FIGS. 21-30, through outlet tubing 97 (not shown) in FIGS. 36 or 37.

Referring now to FIG. 38 there is shown a further embodiment of a drinkable/potable water collecting apparatus utilizing the single chamber 9 version outlined in FIGS. 36 and 37. Here, two solar flumes 1 are utilized. These have been designated 1a and 1b respectively. Each of the flumes 1a and 1b has a base part 3 with a sheet first covering 5 that defines a first air chamber 9. Flume 1a is produced in accordance with the embodiment shown in FIG. 36 and has a gutter 95 on each side of the flume. Black swimming pool heater strip panels 165 are laid parallel to each other and extend along the length of the flume 1a. Flume 1b is of similar construction, except that it does not include the gutters 95. Each of the flumes 1a and 1b are held to a supporting surface such as the ground by pegs 63 in a similar manner to that disclosed in previous embodiments. A fluid such as water fills the hollow interior of the heater strip panels 165. The heater strip panels 165 are fluidly interconnected from flume 1a to flume 1b by fluid conduits 167. Accordingly, flume 1b heats the fluid such as water in the conduits 165 within the first chamber 9 therein. The heated fluid is then caused to flow into the heater strip panels 165 in the flume 1a. Accordingly, fluid such as water is heated in the solar flume 1b and then provided into solar flume 1a where it is further heated within the first chamber 9 in the flume 1a. The heated fluid flow direction is shown by the arrows 169 in FIG. 38.

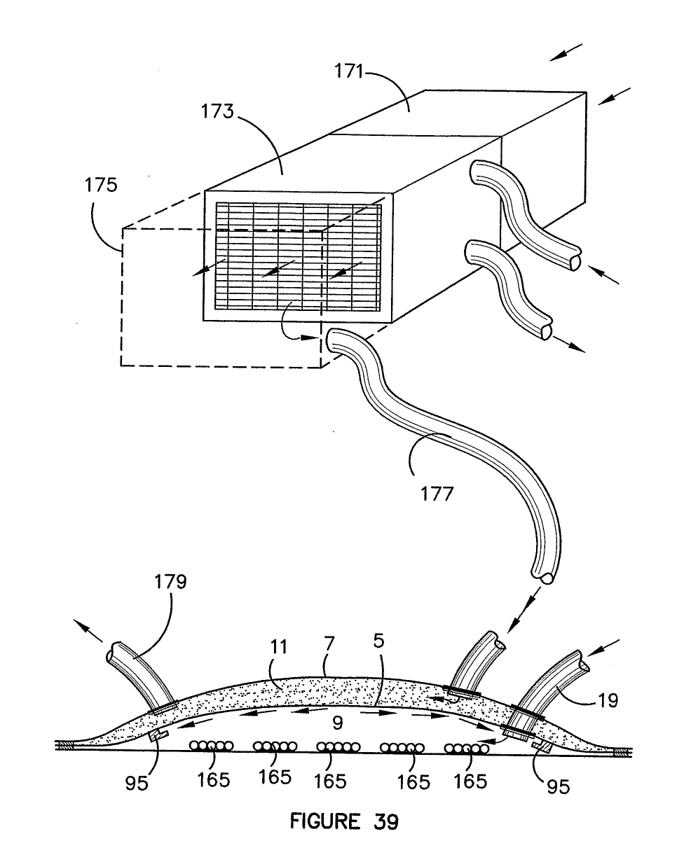

The nondrinkable/nonpotable water is then introduced into the flume 1a from a header tank (not shown) similar to that in the previous embodiments. The nondrinkable/nonpotable water is caused to be directed between the adjacent tubular openings of the heater strip panels 165. In other words, the nondrinkable/nonpotable water is not introduced into the interior of the heater strip panels 165 but in the channels on the upper surface thereof. This distributes the nondrinkable/nonpotable water across the flume 1. The nondrinkable/nonpotable water is then heated by a dual heating process comprising the heat absorbed into the solar flume 1a and by the heat imparted into the heater strip panels 165 in the solar flume 1a. Thus, it can be seen that the solar flume 1b heats fluid and the heat from that fluid provides supplemental heat into the flume 1a. This, in turn, raises the temperature of the nondrinkable/nonpotable water and assists evaporation. The water, in turn, condenses on the under surface of the first layer 3 and collects in the gutters 95. The fluid is then drained off from the gutters 95 through tubing 97 and collected for storage. The nondrinkable/nonpotable water may be collected at the opposite end of flume 1a in a similar collection trough 105 as shown in previous embodiments, and the nondrinkable/nonpotable water recirculated to the header for further distribution back into the solar flume 1a. Strips of water absorbent cloth may be laid over the heater strip panels 165 and the base part 3 to further assist exposure of the water to evaporation. This arrangement is therefore similar to the arrangement previously recited where a geotextile cloth is proposed. FIG. 39 shows a modified version of the embodiment shown in FIG. 38. Here, solar flume 1a is provided with a second covering 7 (as in previous embodiments) and a positive air pressure supplier in the form of an air fan/pump 171 causes atmospheric ambient temperature air to pass through a heat exchanger 173 where the ambient temperature atmospheric air is cooled to a temperature lower than that of ambient. The heat exchanger 173 can be any convenient heat exchanger, but typically comprises a core like a radiator core which has multiple fins therein for heat exchange. The cooled air then passes into a plenum chamber 175, and then via tubing 177, to inflate the second chamber 11 formed between the first covering 5 and the second covering 7. In this way, there is a temperature interface across the first covering 5. This temperature interface has a sufficient thermal difference between the air temperature within the first chamber 9 and the second chamber 11 that it assists condensation of the drinkable/potable water onto the under surface of the first covering 5. An outlet tubing 179 permits a controlled flow of air from the second chamber 11 to atmosphere.

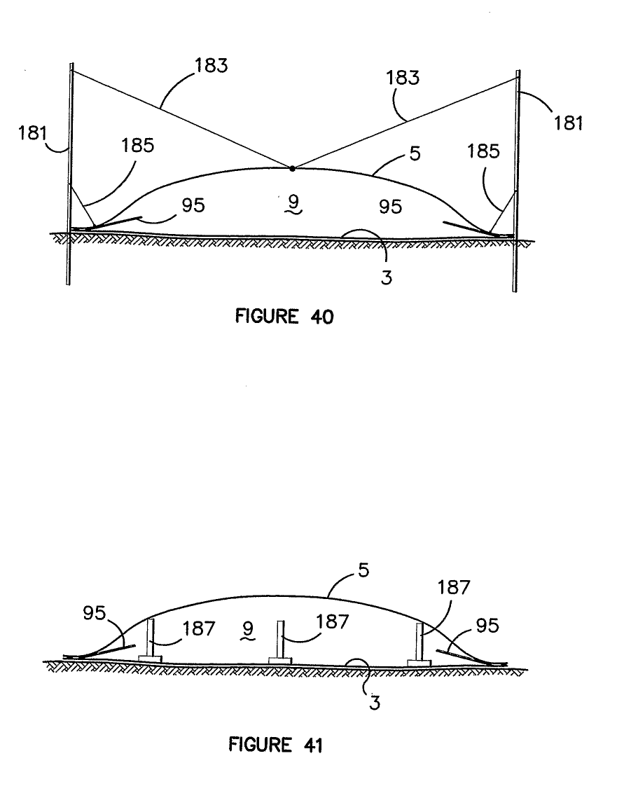

FIG. 40 is a schematic view of an arrangement that can be used in any one of the preceding embodiments to hold up the first covering 5 in the event the air pressure supply to the first chamber 9 fails. Whilst this arrangement has been shown where only a first chamber 9 is used, is also applicable to the embodiments where a second chamber 11 is used. Here, pairs of upright stakes 181 are driven into the ground at each side edge of the flume. The stakes may be spaced longitudinally along the length of the flume at intervals of between 1-2 metres. The exact spacing is not critical except that the end requirement is to support the first covering 5 from contacting the base part 3 in the event the air pressure supply to the chamber 9 (or chamber 11) fails. In this arrangement, and particularly when drinkable/potable water is being recovered on the under surface of the first covering 5 and into the gutters 95, there will not be contamination of the under surface of the first covering 5 by contacting the nondrinkable/nonpotable water that may be on the base part 3. Here, the stakes 181 carry chords 183 that connect with an upper and generally central part of the first covering 5 (and/or the second covering 7). Here the chord may be similar to fishing line chord or indeed any other convenient chord. The chord can be threaded through the first covering 5 (and/or the second covering 11) by piercing the covering with a curved needle and threading chord 183 through any punctured holes created thereby. The chord 183 can then be tied off. It has been found that the plastics material coverings of the first covering 5 and second covering 7 are generally sufficiently strong in themselves to not tear or rupture when pierced in this way. If desired any holes that are made by the attachment process may be sealed by a suitable sealant such as duct tape. Alternatively, no sealing may be provided and air within the first chamber 9 (and/or the second chamber 11) may be allowed to escape to atmosphere through the resulting openings. FIG. 40 also shows that a second set of chords 185 is used to connect in a similar manner to a position just below the gutters 95. The second chords 185 hold up the gutters 95 from contacting the nondrinkable/nonpotable water that may be on the base part 3 and prevent contamination of any water that may be within the gutters 95. This arrangement also inhibits contamination of the gutters 95 themselves.

FIG. 41 shows a further schematic view showing an alternative means of supporting the second covering 5 above the base part 3. Here, a series of upright posts 187 are placed within the first chamber 9. The posts may be made of any suitable material such as extruded plastics material. The posts 187 may run continuously along the length of the flume or may be short length upright posts placed at various spaced apart positions along the longitudinal extent of the flume. The posts 187 are shown having an upright trunk part with a base part that lies over the top of the base part 3 of the flume. Desirably, the upright posts 187 should be arranged to minimize water seepage from the bottom of the posts 187 to the top of the posts 187. In this way, contamination of the under surface of the first covering 5 can be inhibited. Similar upright posts 187 can be inserted over the top of the first covering 5 to maintain the second covering 7 from contacting the first covering 5.

Throughout the description of the embodiments, the base part 3, plastics materials sheet first covering 5, plastics materials sheet second covering 7, have been described as being of highly flexible P.V.C. plastics sheet material. It is conceivable that the principles of the invention can be incorporated by utilizing more rigid plastics material sheets such as semi-rigid sheets that can be pre-shaped to the required configurations. Thus, in these arrangements, the first chamber 9 and second chamber 11 may be provided without the need to physically inflate the chambers themselves to cause the collector to assume the desired configuration. Air would still be pumped into the respective chambers 9 or 11 to provide a positive air supply pressure therein and to allow heated air to be recovered from the collector. In this arrangement, the flume 1 may be pre-manufactured in short length units of say 1 m width by 1 m in length. A number of such units may be interconnected together to form the complete flume 1. Accordingly, the inventive concept also extends to the use of substantially more rigid sheet material than that described in relation to the previous embodiments herein. It is considered however, that the flexible plastics sheet material described in relation to the previous embodiments is the most economical form of providing the flume and therefore the flexible sheet material is better as it can be rolled for ease of transport. Further, it is substantially light in weight and easily maneuverable in a collapsed condition.

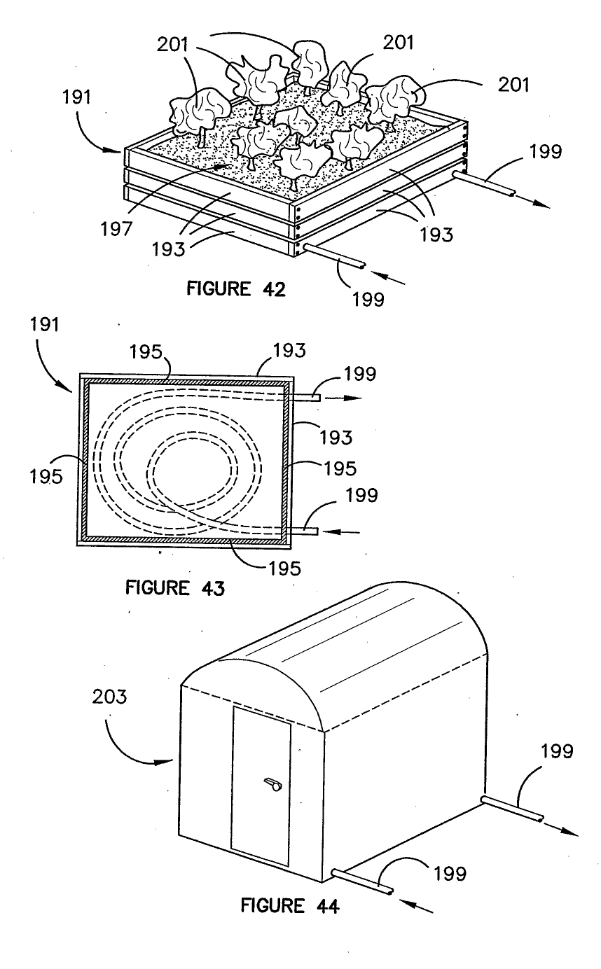

Referring now to the embodiment shown in FIGS. 42 and 43, there is shown how heated fluid obtained from any one of the previous embodiments that heats fluids such as air or liquid in the flume 1 can be used to facilitate growing of plants such as agricultural crop plants. The embodiment shown is particularly suitable for growing tomato crops, but the principles apply to the growing of any crops. Here, there is provided a raised planter box 191. The planter box is typically fabricated from slats 193 such as treated pine or other suitable material that inhibits against rot or weathering. In the examples shown, the planter box 191 is typically about 3 meters in length and 2.0 meters in width. The planter box is typically 0.5 meters high and fabricated from three slats 193 stacked one on top of the other. The floor of the planter box 191 and the upright sides formed by the slats 193 are lined with a thermal insulating material 195 (see FIG. 43). Black polyethylene irrigation pipe 199 of 9 mm in diameter is coiled centrally within the planter box 191. Approximately a 50 meter length of the polyethylene irrigation pipe 199 is used to provide the coil (see FIG. 43). The planter box 191 is then filled with a soil like growing medium 197 and filled to approximately the top of the planter box 191. Crops such as tomatoes 201 are planted in the soil like growing medium 197.

The fluid being liquid in this embodiment is heated from the solar flume 1 and is passed through the irrigation pipe 199 to heat the soil within the planter box 191. The heat from that fluid then exchanges into the soil like growing medium 197 and, typically for tomatoes, the temperature of the soil can be regulated to about 16.5° C. optimal by controlling the flow rate of the fluid that passes through the irrigation pipe 199. A typical temperature control flow circuit for fluids can be utilized to maintain the temperature at a desired temperature such as ABOVE 15.0° C. at night and above 23° C. during daylight. The upper surface of the soil or like growing medium 197 can be thermally insulated by a suitable thermal insulation material such as cocoa fibre. In this case, the cocoa fibre may be applied so that it has a depth of about 10 cm.

The arrangement is such that planter box 191 provides drainage to any liquid that is applied to the crops 201 to promote growth.

FIG. 44 shows a further embodiment where the planter box 191 shown in FIGS. 42 and 43 can be installed within a hothouse 203. The heat radiated from the irrigation pipe 199 will also provide heat to the air within the hothouse 203 and assist maintaining temperature to the foliage of the crop 201 and thereby further enhance growth of the crop 201. The hothouse 203 may be fabricated from UV stablised PVC sheets of approximately 181 microns in thickness. The hothouse 203 may have a frame made of galvanised steel or like structural material (not shown). In a further embodiment similar to that in FIG. 5, heated liquid such as water may be obtained from the flume 1 and passed into large liquid containers that are maintained within the hothouse 203. In this arrangement, the large containers, such as 44 gallon drums, or other drums of similar volume capacity, can be utilised to store heated water and to radiate the heat of the stored water from the external surfaces of the drums. Thus, the hothouse 203 can be heated by the liquid that has, in turn, been heated by the solar flume 1. In a further arrangement the black irrigation pipe 191 may be embedded within a concrete floor of the hothouse, so the floor is heated, and so it can, in turn, cause heat exchange with air in the hothouse 203.

Advantages and objects of the invention can be ascertained from the foregoing description.

It is to be understood that, if any prior art publication is referred to herein, such reference does not constitute an admission that the publication forms a part of the common general knowledge in the art, in Australia or any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

Modifications may be made to the invention as would be apparent to persons skilled in the art. These and other modifications may be made without departing from the ambit of the invention the nature of which is to be determined from the previous description.

1. An elongate solar collector with a plastics material sheet base part, and a plastics material sheet first covering overlaying the base part,
the first covering interconnected relative to the base part at peripheral side edges thereof to define a first air chamber between said base part and said first covering said first chamber extending the full width and full length of the solar collector,
the first covering being transparent or translucent to allow solar energy to transmit therethrough, and the surface of the base part that faces internally of the first chamber being heat absorbing to assist solar energy absorption into the first chamber,
and a positive air pressure supplier for supplying positive pressure air into the first chamber so the air will be heated by solar energy passing into the first chamber through the first covering.

2. A solar collector as claimed in claim 1 wherein the base part and the first covering are flexible sheets, and the collector is inflatable from a collapsed condition to an in use condition by said positive pressure air.

3. A solar collector as claimed in claim 1 wherein the base part and the first covering have substantially the same transverse dimensions in a direction across the width of the solar collector.

4. A solar collector as claimed in claim 1, wherein there is a plastics material sheet second covering overlying the first covering, the first covering and the second covering being interconnected to define a second air chamber extending the full width and full length of the solar collector, and wherein the positive air pressure supplier also supplies a positive pressure air to the second air chamber and wherein the air in the second chamber will act as a thermal insulating material for air in the first chamber.

5. A solar collector as claimed in claim 4 wherein the second covering has a greater transverse dimension in a direction across the width of the solar collector than a corresponding width across the base part or the first covering but wherein the interconnection to the first covering is or is approximately at the same interconnection as the interconnection of the first covering to the base part so that when the first and second chambers are inflated by the positive pressure air, the first chamber will have a greater volume than the second chamber.

6. A solar collector as claimed in claim 1 wherein the surface of the base part opposite to the surface that is heat absorbing is configured for inhibiting heat radiation transfer from the first chamber.

7. A solar collector as claimed in claim 6 wherein the configuration is by colouring the surface of the base part opposite to the surface that is heat absorbing a lighter colour than the colour of the surface that is heat absorbing.

8. A solar collector as claimed in claim 4 wherein the base part, the first covering, and the second covering are of UV stabilised P.V.C. sheets.

9. A solar collector as claimed in claim 1 wherein the interconnection of the first covering relative to the base part is by a sealing weld or bond.

10. A solar collector as claimed in claim 9 wherein the interconnection of the second covering relative to the first covering is by a sealing weld or bond.

11. A solar collector as claimed in claim 4 wherein the interconnection of the first covering and the second covering relative to the base is at a common sealing weld or bond.

12. A solar collector as claimed in claim 4 wherein the base part is relatively rigid compared to the first covering or second covering.

13. A solar collector as claimed in claim 4 wherein the base part is substantially thicker than the thickness of the first covering or the second covering and has a substantially higher thermal conductivity insulating property to that of the first covering or the second covering.

14. A solar collector as claimed in claim 1 wherein the solar collector is manufactured as a collapsed elongate strip collector, and so that the collector strip can be cut to a desired length and the cut ends either closed or directed to an air outlet to complete a collector circuit.

15. A solar collector as claimed in claim 1 wherein position fastening means is provided along the side edges of the strip to permit fasteners to be applied to the collector to co-operate with the position fastening means to hold the base against an underlying supporting surface.

16. A solar collector as claimed in claim 15 wherein the position fastening means comprises an elongate member or the like extending along each side edge of the strip and integrally attached relative to the base along the length of the collector.

17. A solar collector as claimed in claim 1 wherein air that is heated in said first chamber is directed out of the collector through ducting connected with the first chamber by the positive pressure air in the first chamber.

18. A solar collector as claimed in claim 1 wherein the first chamber has a heat collecting passageway therein for receipt of water, so in use, water will be heated in said heat collecting passageway by air that is heated in said first chamber.

19. A solar collector as claimed in claim 18 wherein the heat collecting passageway is connected with a hot water storage tank by means of an interconnected water passageway circuit.

20. A solar collector as claimed in claim 19 wherein the interconnecting water passageway circuit is connected with a solar hot water heater panel so that water heated by the air that is heated in the first chamber acts as a pre-heater for the solar heater panel and acts to supplement the heat collected by the solar heater panel.

21. A solar collector as claimed in claim 1 wherein the air that is heated in the first chamber is passed through an interconnecting air passageway outlet circuit so that the output air will pass to a heat storage bank and provide heat to the heat storage bank so that, at a subsequent time, the air passageway outlet circuit can circulate air to recover heat from the heat storage bank without the circulated air passing through the first chamber.

22. A solar collector as claimed in claim 1, and including a liquid introducer for introducing a layer of liquid onto the base part through a header and so that in use, said liquid will be allowed to evaporate in the first chamber and condense on the under surface of the first covering from where it can be collected.

23. A solar collector as claimed in claim 22 wherein the first covering is upwardly convex so that water that condenses on the under surface thereof can flow by gravity to the side edges thereof from where it can be collected.

24. A solar collector as claimed in claim 22 wherein gutters are provided at the side edges of the collector and within the first chamber to receive water that condenses on the under surface of the first covering and which has moved by gravity to side edges of the collector.

25. A solar collector as claimed in claim 22 wherein liquid flow control restraining means is provided in the first chamber to limit the flow rate of the liquid along the length of the collector whereby to enhance evaporation of the liquid within the first chamber.

26. A solar collector as claimed in claim 22 wherein the liquid flow control restraining means comprises surface undulations on the surface of the base part that faces inwardly of the first chamber.

27. A solar collector as claimed in claim 23 when dependent on claim 4, wherein the positive air pressure supplier supplies air to the second chamber, at a temperature lower than air supplied to the first chamber whereby to provide a temperature interface at the first covering that will assist condensation of liquid onto the under surface of the first covering.

28. A solar collector as claimed in claim 27 including a heat exchanger for cooling air delivered from said positive air pressure supplier to said second chamber to a temperature below that of ambient atmospheric air.

29. A method of obtaining drinking/potable water from a water that is otherwise undrinkable and where drinking/potable water can be obtained by evaporation and subsequent condensation of the otherwise undrinkable water comprising:
providing an elongate solar collector with a plastics material sheet base part,
the first covering being interconnected relative to the base part at peripheral side edges thereof to define a first air chamber, between said base part and said first covering that extends the full width and full length of the solar collector,
the first covering being transparent or translucent to allow solar energy to transmit therethrough, the surface of the base part that faces internally of the first chamber being heat absorbing to assist solar energy absorption into the first chamber,
supplying a positive pressure air in the first chamber so the air will be heated by solar energy passing into the first chamber through the first covering,
introducing a layer of said undrinkable water to said base part,
allowing said undrinkable water in said layer to evaporate and condense on the under surface of said first covering,
collecting the condensate as drinking/potable water and
removing the collected drinkable/potable water from the collector.

30. A method as claimed in claim 29 wherein the solar collector has a plastics material sheet second covering overlaying the base part and interconnected relative to the first covering, there being a second chamber between the first covering and the second covering said second chamber extending the full width and full length of the solar collector, and
Supplying a positive air pressure to the second chamber whereby the air in the second chamber will act as a thermal insulating medium for air in the first chamber.

31. A method as claimed in claim 30 including cooling air that is applied under positive pressure to the second chamber to a temperature lower than air applied under positive pressure to the first chamber to provide a temperature interface at the first covering to assist condensation of the drinking/portable water on the under surface of the first covering.

32. A method of recovering minerals or deposits from a liquid that contains such minerals or deposits comprising:
providing an elongate solar collector with a plastics material sheet base part, and a plastics material sheet first covering overlaying the base part,
the first covering and the second covering being interconnected relative to the base part at peripheral side edges thereof to define a first air chamber, said first chamber being between said base part and said first covering and extending the full width and full length of the solar collector,
the first covering being transparent or translucent to allow solar energy to transmit therethrough, the surface of the base part that faces internally of the first chamber being heat absorbing to assist solar energy absorption into the first chamber,
supplying a positive pressure air in the first chamber so the air will be heated by solar energy passing into the first chamber through the first covering,
introducing a layer of said liquid to said base part,
allowing said liquid to evaporate and condense on the under surface of said first covering and to leave deposits of said minerals or deposits within said first chamber, and
subsequently recovering the deposited minerals or deposits from said first chamber.

33. A method as claimed in claim 32 wherein the solar collector has a plastics material sheet second covering overlaying the base part and interconnected relative to the first covering, there being a second chamber between the first covering and the second covering said second chamber extending the full width and full length of the solar collector, and
Supplying a positive air pressure to the second chamber whereby the air in the second chamber will act as a thermal insulating medium for air in the first chamber.
